(19) United States
(12) Patent Application Publication
(10) Pub. No.: US 2007/0192591 A1
(43) Pub. Date: Aug. 16, 2007

(54) Information processing apparatus preventing unauthorized use

(75) Inventors: Manabu Yumoto, Nara-shi (JP); Masayuki Ehiro, Osaka (JP); Nobuhisa Tsuji, Osaka (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/657,098

(22) Filed: Jan. 24, 2007

(30) Foreign Application Priority Data
Feb. 13, 2006 (JP) 2006-035404

(51) Int. Cl. H04L 9/00

(52) U.S. Cl. 713/159

(57) ABSTRACT

A degree of security set for an application and a valid time corresponding to the degree of security are stored in a memory. When an authentication unit performs user authentication using a fingerprint image input through an authentication information input unit and authorizes use of the application by the user, a control unit monitors lapse of the valid time corresponding to the application. When the valid time expires, the control unit request the user to input authentication information, and authentication is repeated at the authentication unit.

This nonprovisional application is based on Japanese Patent Application No. 2006-035404 filed with the Japan Patent Office on Feb. 13, 2006, the entire contents of which are hereby incorporated by reference.

### BACKGROUND OF THE INVENTION

1. Field of the Invention

The present invention relates to an information processing apparatus, an authentication method, an authentication program, and a recording medium storing the authentication program. Specifically, the present invention relates to an information processing apparatus, an authentication method, an authentication program, and a recording medium storing the authentication program that can prevent unauthorized use of equipment.

2. Description of the Background Art

An information processing apparatus has been known of which use is not allowed until after individual authentication is done using a piece of information identifying an individual. The user can execute a desired process only when the authentication is successful.

Assuming that a user activates an application of an information processing apparatus, a process for performing individual authentication in the information processing apparatus and limiting use by the user will be described with reference to a flowchart of FIG. 7. The process shown in FIG. 7 is started when activation of the application is instructed by a user operation or the like.

Referring to FIG. 7, when the application is activated (step G01), a control unit of the information processing apparatus outputs a control signal to start authentication to an authentication function, so that individual authentication utilizing a piece of information identifying an individual starts (step G01).

If user authentication fails (NO at step G02) as a result of authentication process of step G02, the control unit of information processing apparatus sends a control signal not allowing execution of the activated application (step G04). Consequently, the process by the application is not allowed.

If user authentication at step G02 succeeds (YES at step G02), the control unit allows use of the application, and goes on to output a control signal to the application to start an operation (step G03).

Various proposals, such as password authentication and authentication using biometric information, have been made as the individual authentication utilizing a piece of information identifying an individual. Among these, an authentication using fingerprint collation has been known as authentication using biometric information. At step G02 described above, an authentication process utilizing fingerprint collation may be executed.

Such an authentication process executed in the information processing apparatus prevents unauthorized use by an unauthorized user when the application is activated. Once the user authentication succeeds, however, use is basically allowed for a prescribed time period or until the power is turned off, without further execution of the authentication process. Therefore, when the user briefly leaves away from the information processing apparatus that authorized use by the user, it is possible for a third party to use the apparatus.

In order to solve this problem, Japanese Patent Laying-Open No. 2004-077990 (hereinafter denoted as Patent Document 1) discloses a method in which an information processing apparatus enters a power-saving standby mode referred to as a sleep mode when the authorized user temporarily leaves away from the information processing apparatus, a fingerprint authentication mechanism is provided on a specific button, such as a sleep button, and when the sleep mode is to be cancelled, fingerprint authentication is performed. By this method, it is possible to prevent use by a third party when the authorized user briefly leaves from the apparatus of which use is authenticated.

Even when the method disclosed in Patent Document 1 is adopted in the information processing apparatus, however, it is still possible by a third party to use the apparatus, if the time period set to enter the sleep mode is long and the third party accesses to the apparatus before entrance to the sleep mode. On the other hand, if the time period to enter the sleep mode is set too short, the operation may enter the sleep mode during use of the authorized user if he/she does not operate the apparatus for a while, which is inconvenient.

As described above, when priority is given to security, convenience would be sacrificed, and when priority is given to convenience, security would be sacrificed. Considering functions, some put higher priority on security than convenience, some put higher priority to convenience than security, and some do not necessarily require both high security and high convenience.

### SUMMARY OF THE INVENTION

The present invention was made in view of the problems described above, and an object is to provide an information processing apparatus, an authentication method, and an authentication program product that involve user authentication considering a balance between security and convenience.

In order to attain the above-described object, according to an aspect, the present invention provides an information processing apparatus, including: a storage unit storing a degree of security set for a function of the information processing apparatus, and a function valid time corresponding to the degree of security; an authentication information obtaining unit obtaining authentication information as a piece of information for identifying a user; an authentication unit authorizing use of the function by the user, using the authentication information; and a control unit requesting, when it is detected that the function valid time corresponding to the degree of security set for the function has elapsed since the start of use of the function, the authentication information and causing the authentication unit to execute the authentication.

Therefore, when use of a function starts, authentication is executed at every valid time period set corresponding to the degree of security. Therefore, even if authentication is done once and thereafter an unauthorized third party should use the function, authentication information is requested after expiration of the valid time period, and hence, continued unauthorized use can be prevented.

Preferably, the function includes a first function and a second function; the degree of security includes a first degree of security and a second degree of security lower than the first degree of security; a first function valid time corresponding to the first degree of security is shorter than a second function valid time corresponding to the second degree of security; and when the first degree of security is set for the first function and the second degree of security is set for the second function, the control unit requests, when it is detected that the first function valid time has elapsed since the start of use of the function, the authentication information related to use of the first function to execute the authentication, and when it is detected that the second function valid time has elapsed, the authentication information related to use of the second function to execute the authentication.

Specifically, repeated authentication is executed in order, from corresponding functions having higher degree of security to lower degree of security. Therefore, a function having higher degree of security requires authentication with shorter time interval, preventing unauthorized use, while a function having lower degree of security has long interval for authentication, ensuring convenience.

Preferably, the first function having higher degree of security specifically includes the function of electronic commercial transaction. Preferably, the second function having lower degree of security specifically includes the function of electronic mail processing function and the call processing function.

Preferably, the control unit limits use of the function by the user, when authentication of the user at the authentication unit fails.

Further, preferably, the authentication information is information derived from biologic body. More specifically, the information derived from biologic body is preferably a fingerprint image.

In that case, preferably, the authentication information obtaining unit obtains first and second fingerprint images as the authentication information; and the authentication unit includes a maximum matching score position searching unit searching for a position of an image of a partial area having maximum matching score in the second fingerprint image, corresponding to each of a plurality of partial areas set in the first fingerprint image, a similarity score calculating unit calculating a similarity score between the first and second fingerprint images and outputting an image similarity score, using information related to that partial area of which positional relation amount is within a prescribed range, the positional relation amount representing positional relation between a reference position, for each of the partial areas, for specifying a position of the partial area within the first fingerprint image, and the maximum matching score position corresponding to the partial area searched out by the maximum matching score position searching unit, and determining unit determining whether the first and second fingerprint images match or not, based on the image similarity score.

Further, preferably, the similarity score calculating unit calculates and outputs as the image similarity score, the number of the partial areas of which distance and direction of the maximum matching score position searched by the maximum matching score position searching unit from the reference positions are within the prescribed range among the plurality of partial areas.

According to another aspect, the present invention provides, in an information processing apparatus storing a degree of security set for a function and a function valid time corresponding to the degree of security, a method of authentication, including: authentication information obtaining step of obtaining authentication information as information for identifying a user; authentication step of authorizing use of the function by the user using the authentication information; and control step of requesting, when it is detected that the function valid time corresponding to the degree of security set for the function has elapsed since the start of use of the function, the authentication information and executing the authentication.

According to a still further aspect, the present invention provides a program product causing an information processing apparatus to execute an authentication process, wherein the information processing apparatus stores a degree of security set for a function and a function valid time corresponding to the degree of security; the authentication process including authentication information obtaining step of obtaining authentication information as information for identifying a user; authentication step of authorizing use of the function by the user using the authentication information; and control step of requesting, when it is detected that the function valid time corresponding to the degree of security set for the function has elapsed since the start of use of the function, the authentication information and executing the authentication.

The information processing apparatus in accordance with the present invention is configured such that repeated authentication is required for a function having high degree of security after a short period of time from the start of use. Therefore, even when the authorized user leaves the apparatus without setting the apparatus to an unusable state, unauthorized use by the third party can be prevented.

Further, it is configured such that a function having lower degree of security requires repeated authentication after a longer time period than the function having higher degree of security. Therefore, the number of operations for user authentication can conveniently be made smaller than for a function of higher degree of security, while unauthorized use by a third party can still be prevented as repeated authentication is required after a prescribed time period even if the third party should use the function.

As described above, the information processing apparatus in accordance with the present invention realizes, with good balance, high security necessary for electronic commercial transaction and the like, and convenience necessary for electronic mail processing function and the like.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram of a processing apparatus 1 with the authentication function in accordance with Embodiment 1.

FIG. 2 shows a configuration of a computer in which processing apparatus 1 with authentication function in accordance with Embodiment 1 is mounted.

FIG. 3 shows a specific example of a table storing correspondence between security rank and application valid time, and applications classified by the security rank.

FIG. 4 is a flowchart representing a process in processing apparatus 1 with authentication function in accordance with Embodiment 1.

FIG. 5 is a flowchart representing an example of the authentication process at step F01.

FIG. 6 is a flowchart representing a process of calculating similarity score between images A and B at step T16.

FIG. 7 is a flowchart of a process of limiting use by a user through individual authentication, in a conventional information processing apparatus.

### DESCRIPTION OF THE PREFERRED EMBODIMENTS

In the following, embodiments of the present invention will be described with reference to the figures. In the following description, the same or corresponding components are denoted by the same reference characters. Their names and functions are also the same.

### Embodiment 1

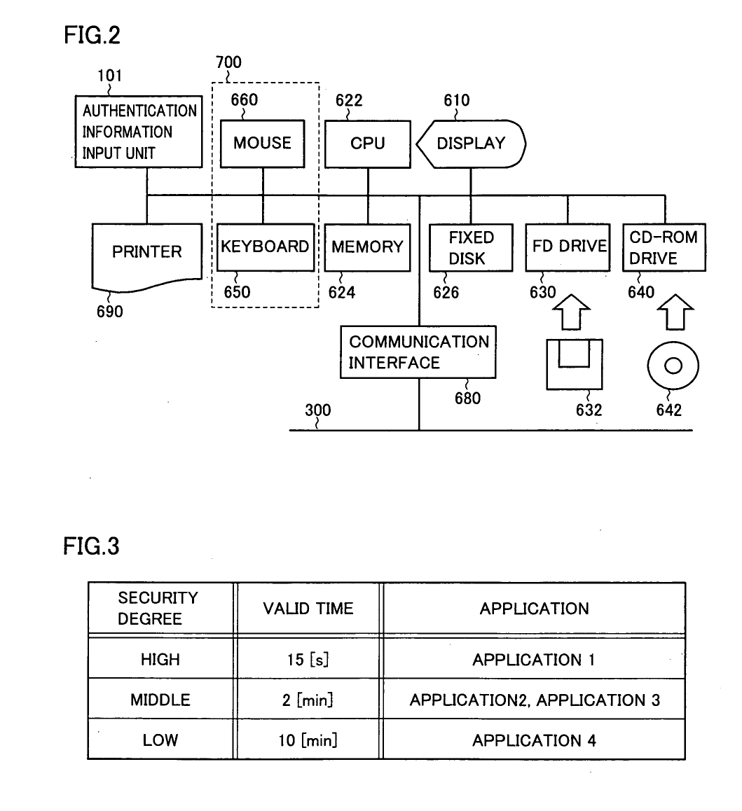

Referring to FIG. 2, a computer, in which a processing apparatus 1 with authentication function in accordance with Embodiment 1 is mounted, is configured to include an authentication information input unit 101, a display 610 formed of a CRT (Cathode Ray Tube) or liquid crystal, a CPU (Central Processing Unit) 622 for centralized management and control of the computer itself, a memory 624 implemented by including an ROM (Read Only Memory) or an RAM (Random Access Memory), a fixed disk 626, an FD drive 630 accessing to an FD (Flexible Disk) 632 detachably mounted thereon, a CD-ROM drive 640 accessing to a CD-ROM (Compact Disk Read Only Memory) 642 detachably mounted thereon, a communication interface 680 for connecting the computer to a communication network to establish communication, and an input unit 700 having a keyboard 650 and a mouse 660. These components are connected to each other through a bus for communication, and further to a printer 690 as an external device.

The configuration shown in FIG. 2 is a general computer configuration, and the configuration of the computer in accordance with the present invention is not limited to the one shown in FIG. 2. By way of example, the computer may include a magnetic tape drive accessing to a cassette type magnetic tape detachably mounted thereon.

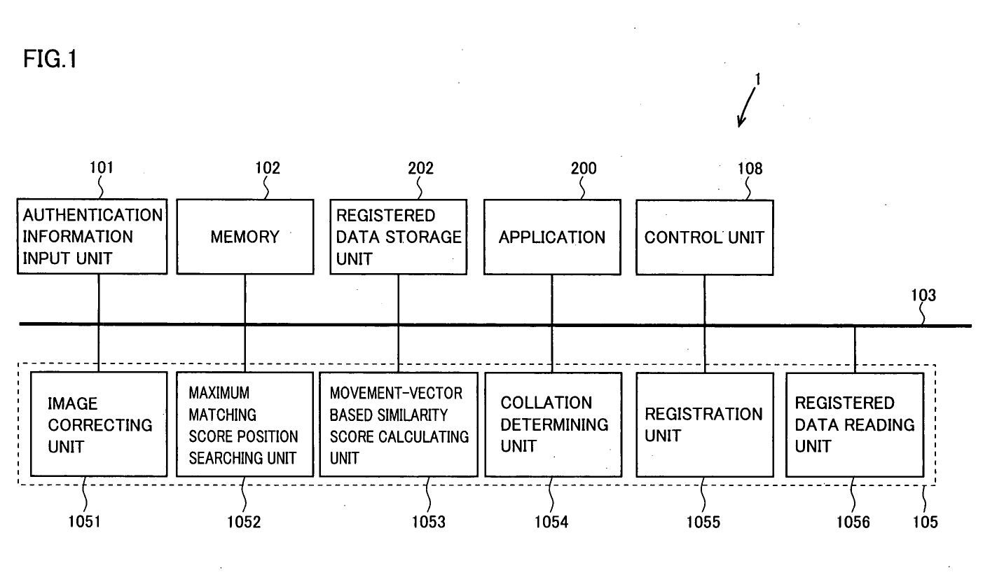

Referring to FIG. 1, processing apparatus 1 with authentication function includes an authentication information input unit 101, a memory 102 corresponding to memory 624 or fixed disk 626 of FIG. 2, a bus 103, an authentication unit 105, a control unit 108, an application 200 and a registration data storage unit 202.

Application 200 may specifically be software for electronic commercial transaction, electronic mail software, office-use software such as word processing software, or communication software. Application 200 is not limited to such software and it may be any other software.

It is assumed that processing apparatus 1 with authentication function may use any information as information for identifying an individual. Preferably, information derived from biologic body (referred to as biometric information) such as fingerprint, palm shape, palm vein, iris, face, voice spectrum, heartbeat, and signature may be used. It is assumed that processing apparatus 1 with authentication function in accordance with the present embodiment authenticates an individual using a fingerprint, as a specific example of information identifying an individual, as the biometric information.

Here, authentication information input unit 101 includes a fingerprint sensor, and a fingerprint image data corresponding to the fingerprint read by the fingerprint sensor is output to memory 102 and stored at a prescribed address. The fingerprint sensor may be an optical type, pressure type or capacitance type sensor. Memory 102 stores image data and various results of calculations. Bus 103 is used for transferring control signals and data signals between each of these units.

Further, authentication unit 105 includes an image correcting unit 1051, a maximum matching score position searching unit 1052, a unit for calculating similarity score based on movement vector (hereinafter referred to as a similarity score calculating unit) 1053, a collation determining unit 1054, a registration unit 1055, and a registered data reading unit 1056. Functions of these units in authentication unit 105 are realized when corresponding programs are executed at control unit 108.

Image correcting unit 1051 corrects shade of fingerprint image data as the information for identifying an individual, used as the authentication information, input from authentication information input unit 101.

Registration unit 1055 extracts data of partial areas R1, R2, . . . , Rn of predetermined positions as information necessary for collation, and successively stores the data at prescribed addresses of registered data storage unit 202. In registered data storage unit 202, only the data portion used for collation is stored in advance, from one image out of two images to be collated. In the following, the fingerprint image registered in registered data storage unit 202 will be referred to as registered fingerprint image.

Registered data reading unit 1056 reads information necessary for collation from registered data storage unit 202 to memory 102.

Maximum matching score position searching unit 1052 is a so-called template matching unit that searches, using a plurality of partial areas of one of the fingerprint image input through authentication information input unit 101 and fingerprint image read to memory 102 as a template, a position of highest matching score with the template in the other fingerprint image. Information of the result is stored in memory 102.

Using the result information of maximum matching score position searching unit 1052 stored in memory 102, similarity score calculating unit 1053 calculates similarity score based on movement vector, which will be described later. Collation determining unit 1054 determines whether these images match or not, based on the similarity score calculated by similarity score calculating unit 1053.

Authentication information input unit 101 and authentication unit 105 described above have a configuration for executing authentication utilizing, as the authentication information, fingerprint information in the form of images, and similar configuration is used when authentication is executed utilizing other images such as faces or signatures. When the authentication is executed utilizing information in the form of voice such as in the case of voice spectrum or utilizing numerical information of iris or the like, corresponding configuration is used.

Control unit 108 controls processes of various units in authentication unit 105.

Further, memory 102 stores correspondence between security rank and valid time of applications, and information related to applications classified by the security ranking. The security rank refers to the degree of security, and valid time of application refers to the time period in which continuous use is allowed after successful authentication.

Referring to FIG. 3, it is assumed that three ranks of high, middle and low securities are set as specific example of security ranking.

Further, Application 1 is set as an application of high degree of security, and the valid time for this application is set to 15 [s]. Among the specific examples of application 200 mentioned above, software for electric commercial transaction requiring high security corresponds to Application 1. Application 2 and Application 3 are set as applications of middle degree of security, and valid time for these applications is set to 2 [min]. Specifically, electronic mail software and office use software requiring middle level security correspond to Applications 2 and 3. Application 4 is set as an application of low degree of security, and the valid time for this application is set to 10 [min]. Specifically, communication application requiring low level security corresponds to Application 4.

The correspondence shown in FIG. 3 is a specific example and the valid time for applications is not limited to those shown in FIG. 3. The time period may be set/changed by the registered user or a specific user such as an administrator. It may be changed at the time of use of the apparatus. Further, classification of applications is not limited to those shown in FIG. 3. Security ranks are not limited to three and, there may be larger number of (or smaller number of) ranks. Classification of applications and security ranking may also be set/changed by a specific user, as in the case of valid time for applications.

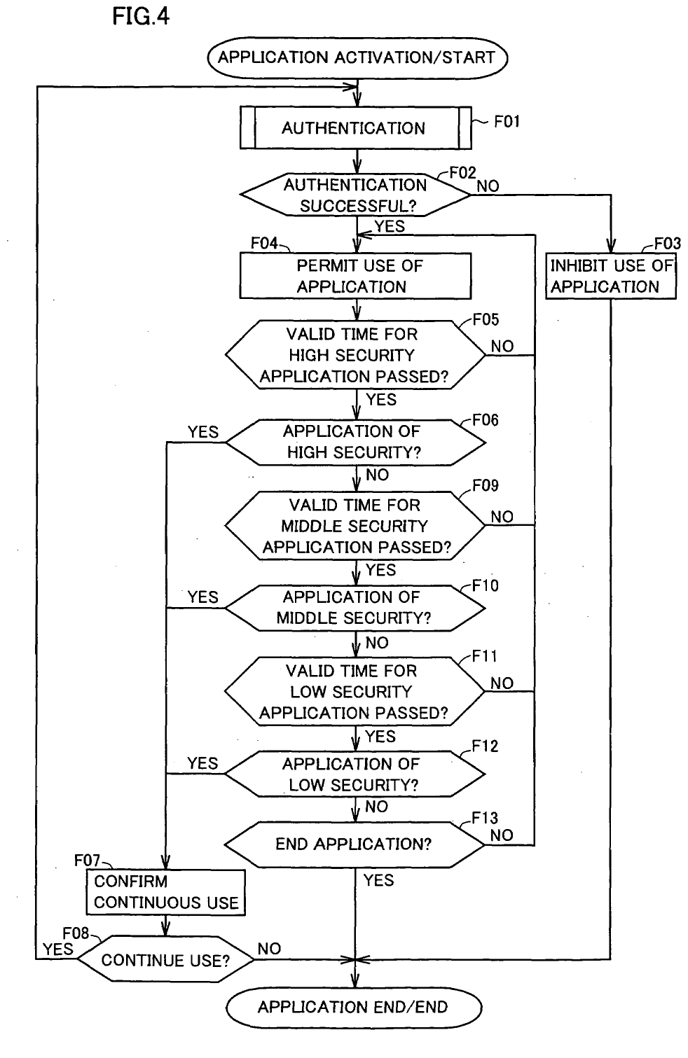

The process of processing apparatus 1 with authentication function in accordance with the present invention shown in the flowchart of FIG. 4 is realized when CPU 622 of the computer mounting processing apparatus 1 with authentication function in accordance with the present embodiment reads the corresponding program stored in the ROM or the like, develops the same on the RAM and executes the program by controlling various units shown in FIG. 1. The process shown in FIG. 4 starts when an instruction to activate application 200 is detected by control unit 108.

Referring to FIG. 4, when control unit 108, detects that the user instructed activation of application 200 using input unit 700 or the like, authentication unit 105 starts the authentication process in accordance with a signal to start authentication from control unit 108 (step F01). Here, it is assumed that a fingerprint is used as the information for identifying an individual and authentication is done by executing fingerprint collation. Details of the process will be described later.

If user authentication fails as a result of fingerprint collation process at step F01 (NO at step F02), control unit 108 transmits a signal not permitting execution to application 200, so that the process of application 200 is not executed (step F03). Here, a notice may be given on display 610 or through a speaker (not shown) that the application is not usable as authentication failed. In view of security, however, such notice may not specifically be given. Further, use of the application may not fully be inhibited but rather the use may be limited to prescribed ranges, including inhibition. Specifically, assuming the software for electronic commercial transaction, restriction may be set such that browsing of transaction contents is permitted while transaction is not permitted; for office use software, restriction may be set such that formation of a new file is permitted while modification of an existing file is not permitted; for electronic mail software, restriction may be set such that formation of a new electronic mail is permitted while browsing/transmission is not permitted; and for call software, reception of a call is permitted while transmission of a call is not permitted.

If user authentication succeeds as a result of the fingerprint collation process at step F01 (YES at step F02), use of application 200 is permitted, and control unit 108 transmits a control signal based on a user operation, to application 200 (step F04).

When use of application 200 starts, control unit 108 refers to the valid time for the application corresponding to the security rank stored in memory 102, and monitors the time lapse while checking the shortest valid time for the applications (step F05). When the correspondence stored in memory 102 is that shown in FIG. 3, here, the lapse of 15 [s], that is, the valid time for an application corresponding to the high degree of security is monitored. When the lapse of time is detected (YES at step F05), whether the activated application 200 is classified to high degree of security or not, or whether the activated application 200 includes any application classified to high degree of security or not is determined (steps F06). When application 200 is an application classified to high degree of security (YES at step F06), control unit 108 confirms whether the user intends to continuously use the application or not, through display 610 or a speaker (not shown) (step S07). Detecting an input of information indicating the intension of continuous use from input unit 700 (YES at step F08), control unit 108 returns the process to step FO1, and the authentication is executed again. Thereafter, the above-described process steps are repeated.

When input of information indicating that the continued use is not intended from input unit 700 is detected, or lack of information indicating the intension of continued use is detected, as in the case where there is no input for a prescribed time period (NO at step F08), control unit 108 ends application 200 directly, and the process is terminated. In place of terminating application 200, a control signal indicating that the execution is not permitted may be transmitted and operations thereafter may be invalidated.

If the activated application 200 is not an application classified to high degree of security, or if the activated application 200 does not include any application classified to high degree of security (NO at step F06), control unit 108 refers to the valid time for an application that is the second shortest among the valid times of applications corresponding to the security ranking stored in memory 102, and monitors the time lapse (step F09). When the correspondence stored in memory 102 is that shown in FIG. 3, here, the lapse of 2 [min], that is, the valid time for an application corresponding to the middle degree of security is monitored. When the lapse of time is detected (YES at step F09), whether the activated application 200 is classified to middle degree of security or not, or whether the activated application 200 includes any application classified to middle degree of security or not is determined (steps F10). If it is the case, control unit 108 confirms whether the user intends to continuously use the application or not in the similar manner (step S07). If it is intended (YES at step F08), the process is returned to step F01, and if not (NO at step F08), application 200 is terminated and the process ends.

Control unit 108 executes this process in order, from the shortest valid time for application corresponding to the security rank (from the highest security rank) stored in memory 102. When the process is done for the application of the longest valid time and the activated application 200 is not an application classified to the low degree of security or the activated application 200 does not include any application classified to the low degree of security, that is, if the application does not require any security (NO at step F12), use of application 200 is continued until a user operation to end the application 200 is detected. When the user operation to end the application is detected (YES at step F13), application 200 is terminated and the process ends.

In the process above, an example has been described in which continued use of the activated application 200 is inhibited at the time point when user authentication fails. It is not limiting, and continued use of the activated application 200 may be inhibited when user authentication fails a set number of times (for example, when authentication fails twice).

Further, at steps F05, 09 and 11 described above, time lapse from the start of use of the application is monitored. The start point is not limited to the start of use of the application, and it may be other time point. By way of example, the time point when user authentication succeeded may be used as the start point; when absence of any input for a prescribed time period is detected during use of the application, the time point when the last operation input was done may be used as the start point; when one same application is activated a number of times, the time point when it was first activated may be used as the start point; or when a plurality of different types of applications are activated, the time point when the first of the applications was activated may be used as the start point, regardless of the type of application.

With the above-described process being executed, the processing apparatus 1 with authentication function in accordance with the present embodiment requires repeated authentication after a short period of time from the start of use, for a function of high degree of security. Therefore, even when an authorized user leaves away from the apparatus without setting the apparatus to an unusable state, unauthorized use by the third party can be prevented.

For a function of lower degree of security, repeated authentication is required after a longer time period than for the function of higher degree of security. Therefore, the number of operations for user authentication can conveniently be made smaller than for the function of higher security, while unauthorized use by a third party can still be prevented as repeated authentication is required after a prescribed time period even if the third party should use the function.

As described above, the processing apparatus 1 with authentication function in accordance with the present embodiment realizes, with good balance, high security necessary for electronic commercial transaction and the like and convenience necessary for electronic mail processing function and the like.

As an example of the authentication process of step F01 described above, an authentication process adopting the method of image collation disclosed in Japanese Patent Laying-Open No. 2003-323618 filed earlier by the applicant and published may be applied, though the process is not limited thereto in the present invention.

An example of the authentication process at step F01 above will be described.

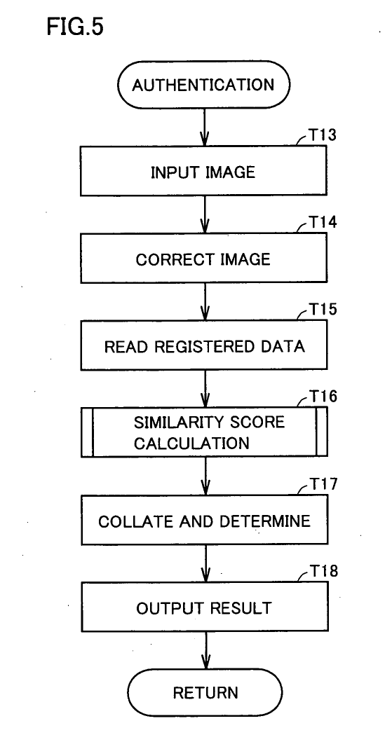

Referring to FIG. 5, first, control unit 108 transmits an image input start signal to authentication information input unit 101, and thereafter waits until an image input end signal is received. Authentication information input unit 101 receives, as an input, a fingerprint image for collation, which image is stored at a prescribed address of memory 102 through bus 103 (step T13). After image input is completed, authentication information input unit 101 transmits the image input end signal to control unit 108. Hereafter, the input image will be referred to as the input fingerprint image.

Thereafter, control unit 108 transmits an image correction start signal to image correcting unit 1051, and thereafter, waits until an image correction end signal is received. In most cases, the input fingerprint image has uneven image quality, as tones of pixels and overall density distribution vary because of variations in characteristics of authentication information input unit 101, dryness of fingerprints and pressure with which fingers are pressed. Therefore, it is not appropriate to use the input image data directly for collation. Thus, image correcting unit 1051 corrects the image quality of input fingerprint image to suppress variations of conditions when the image was input (step T2). Specifically, for the overall image corresponding to the input image or small areas obtained by dividing the image, histogram planarization (Computer GAZOU SHORI NYUMON (Introduction to computer image processing, SOKEN SHUPPAN, p. 98), or image thresholding (binarization) (Computer GAZOU SHORI NYUMON (Introduction to computer image processing, SOKEN SHUPPAN, pp. 66-69) is performed, on input fingerprint images stored in memory 102.

After the end of image correcting process on input fingerprint images stored in memory 102, image correcting unit 1051 transmits the image correction end signal to control unit 108 (step T14).

Next, control unit 108 transmits a registered data read start signal to registered data reading unit 207, and waits for reception of a registered data read end signal.

Receiving the registered data read start signal, registered data reading unit 207 reads data of a partial area Ri of a registered fingerprint image from registered data storage unit 202, and stores the same to a prescribed address of memory 102 (step T15). Thereafter, registered data reading unit 207 transmits an end signal to control unit 108.

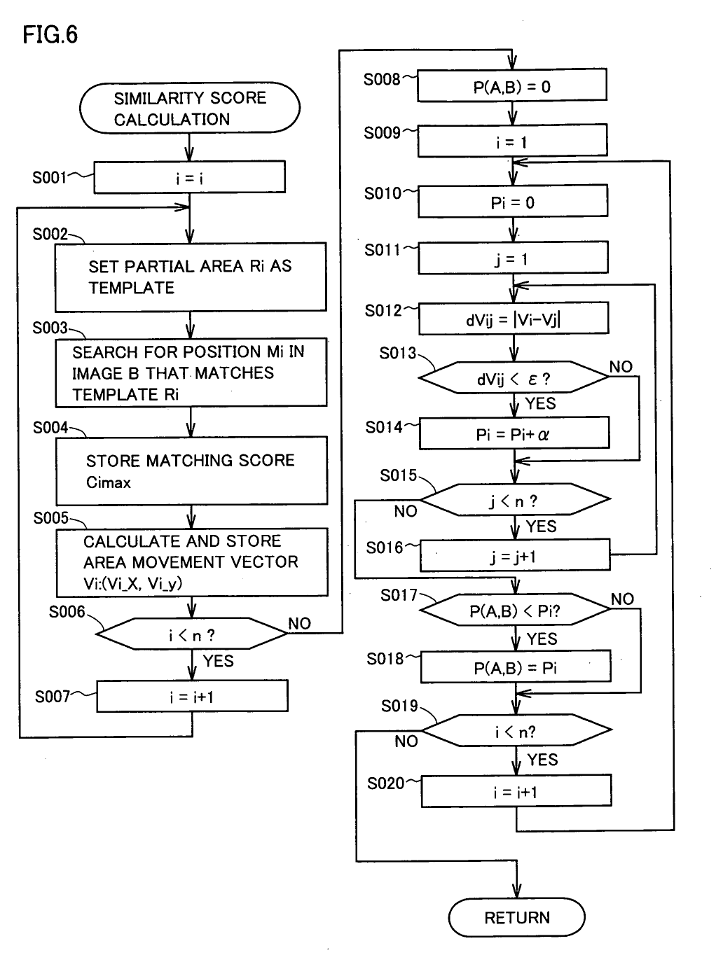

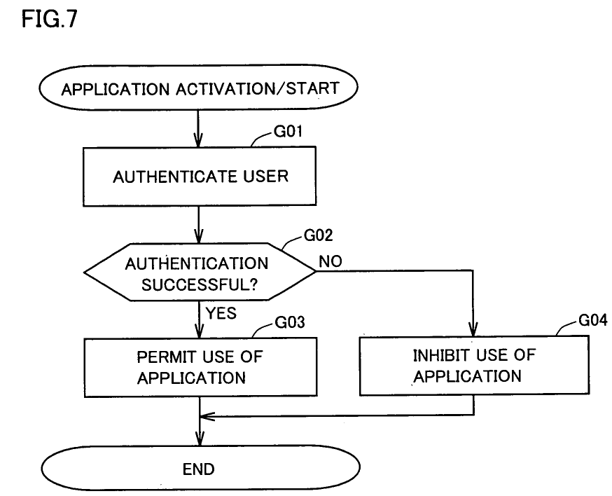

Then, control unit 108 transmits a template matching start signal to maximum matching score position searching unit 1052, and waits until a template matching end signal is received. At step T16, a process for calculating similarity score between the partial area Ri of the registered fingerprint image and the input fingerprint image is executed. Here, the registered fingerprint image is represented by Image A and the input fingerprint image is represented by Image B, and the similarity score calculating process between Images A and B executed at step T16 will be described with reference to the flowchart of FIG. 6.

Referring to FIG. 6, first, maximum matching score position searching unit 1052 starts a template matching process represented by steps S001 to S007. At step S001, a counter variable i is initialized to 1. At step S002, an image of a partial area defined as partial area Ri of Image A is set as a template to be used for the template matching.

Though the partial area Ri has a rectangular shape for simplicity of calculation, the shape is not limited thereto. At step S003, a portion of Image B having the highest matching score with the template set at step S002, that is, a portion at which image data best match the template, is searched for. Specifically, we represent pixel density of coordinates (x, y), with an upper left corner of partial area Ri used as the template being the origin by Ri (x, y), pixel density of coordinates (s, t), with an upper left corner of Image B being the origin by B(s, t), the width and height of partial area Ri by w and h, respectively, possible maximum density of each pixel in Images A and B by V0, and the matching score at coordinates (s, t) of Image B by Ci(s, t), which matching score is calculated in accordance with the following equation, based on density difference between each of the pixels.

$$Ci ( s , t ) = {\sum }_{y = 1}^{h} {\sum }_{x = 1}^{w} ( V 0 - \vert Ri ( x , y ) - B ( s + x , t + y ) \vert ) \qquad ( Equation 1 )$$

In Image B, the coordinates (s, t) are successively updated and the matching score C(s, t) is calculated. A position having the highest value is considered as the maximum matching score position, the image of the partial area at that position is represented as partial area Mi, and the matching score at that position is represented as maximum matching score Cimax. At step S004, the maximum matching score Cimax in Image B for the partial area Ri calculated at step S003 is stored at a prescribed address of memory 102. At step S005, a movement vector Vi is calculated in accordance with equation (2) below, which is stored at a prescribed address of memory 102.

Here, if Image B is scanned to identify the partial area Mi at the position M having the highest matching score with the partial area Ri, based on the partial area Ri at position R set in Image A, a directional vector from position R to position M is referred to as a movement vector. This is because one Image B seems to have moved from the other Image A as a reference, as the finger is placed in various manners on the fingerprint sensor.

Vi=(Vix,Viy)=(Mix−Rix,Miy−Riy) (Equation 2)

In equation (2), variables Rix and Riy are x and y coordinates at the reference position of partial area Ri, that correspond, by way of example, to the upper left corner of partial area Ri in Image A. Variables Mix and Miy are x and y coordinates at the position of maximum matching score Cimax as the result of search of partial area Mi, which correspond, by way of example, to the upper left corner coordinates of partial area Mi at the matched position in Image B.

At step S006, whether the counter variable i is not larger than the total number of partial areas n or not is determined. If the variable i is not larger than the total number n of the partial areas, the flow proceeds to step S007, and otherwise, the process proceeds to step S008. At step S007, 1 is added to variable value i. Thereafter, as long as the variable value i is not larger than the total number n of partial areas, steps S002 to S007 are repeated. Namely, for every partial area Ri, template matching is performed, and the maximum matching-score Cimax of each partial area Ri and the movement vector Vi are calculated.

Maximum matching score position searching unit 1052 stores the maximum matching score Cimax and the movement vector Vi for every partial area Ri calculated successively as described above at prescribed addresses of memory 102, and thereafter transmits a template matching end signal to control unit 108 to end the process.

Thereafter, control unit 108 transmits a similarity score calculation start signal to similarity score calculating unit 1053, and waits until a similarity score calculation end signal is received. Similarity score calculating unit 1053 calculates the similarity score by executing the process of steps S008 to S020, using information such as the movement vector Vi and the maximum matching score Cimax of each partial area Ri obtained by template matching and stored in memory 102.

At step S008, similarity score P(A, B) is initialized to 0. Here, the similarity score P(A, B) is a variable storing the degree of similarity between images A and B. At step S009, an index i of the movement vector Vi as a reference is initialized to 1. At step S010, similarity score Pi related to the reference movement vector Vi is initialized to 0. At step S011, an index j of movement vector Vj is initialized to 1. At step S012, vector difference dVij between reference movement vector Vi and movement vector Vj is calculated in accordance with equation (3).

dVij=|Vi−Vj|=sqrt((Vix−Vjx)²+(Viy−Vjy)²) (Equation 3)

Here, variables Vix and Viy represent x direction and y direction components, respectively, of the movement vector Vi, variables Vjx and Vjy represent x direction and y direction components, respectively, of the movement vector Vj, variable sqrt(X) represents square root of X and X² represents calculation of square of X.

At step S013, vector difference dVij between movement vectors Vi and Vj is compared with a prescribed constant value ε, so as to determine whether the movement vectors Vi and Vj can be regarded as substantially the same vectors. If the vector difference dVij is smaller than the constant value ε, movement vectors Vi and Vj are regarded as substantially the same, and the flow proceeds to step S014. If the difference is larger than the constant value, the movement vectors cannot be regarded as substantially the same, and the flow proceeds to step S015. At step S014, the similarity score Pi is incremented in accordance with equations (4) to (6).

### (Equation 4)

Pi=Pi+α (4)

### (Equation 5)

α=1 (5)

### (Equation 6)

α=Cjmax (6)

In equation (4), variable α is a value for incrementing the similarity score Pi. If α is set to 1 as represented by equation (5), similarity score Pi represents the number of partial areas that have the same movement vector as reference movement vector Vi. If α is set to α=Cjmax as represented by equation (6), the similarity score Pi would be the total sum of the maximum matching scores obtained through the template matching of partial areas that have the same movement vector as the reference movement vector Vi. The value of variable α may be made smaller, in accordance with the magnitude of vector difference dVij.

At step S015, whether the value of index j is smaller than the number n of partial areas or not is determined. If the value of index j is smaller than the number n of partial areas, the flow proceeds to step S016, and if it is larger, the flow proceeds to step S017. At step S016, the value of index j is incremented by 1. By the process from step S010 to S016, the similarity score Pi is calculated, using the information of partial areas determined to have the same movement vector as the reference movement vector Vi. At step S017, the similarity score using movement vector Vi as a reference is compared with the variable P(A, B), and if the similarity score Pi is larger than the largest similarity score (value of variable P(A, B)) obtained by that time, the flow proceeds to step S018, and otherwise the flow proceeds to step S019.

At step S018, a value of similarity score Pi using movement vector Vi as a reference is set to the variable P(A, B). At steps S017 and S018, if the similarity score Pi using movement vector Vi as a reference is larger than the maximum value of the similarity score (value of variable P (A, B)) calculated by that time using other movement vector as a reference, the reference movement vector Vi is considered to be the best reference among the values of index i used to that time point.

At step S019, the value of index i of reference movement vector Vi is compared with the number (value of variable n) of partial areas. If the value of index i is smaller than the number n of partial areas, the flow proceeds to step S020, in which the index value i is incremented by 1.

From step S008 to step S020, similarity between images A and B is calculated as the value of variable P(A, B). Similarity score calculating unit 1053 stores the value of variable P (A, B) calculated in the above described manner at a prescribed address of memory 102, and transmits a similarity score calculation end signal to control unit 108 to end the process.

Thereafter, control unit 108 transmits a collation determination start signal to collation determining unit 1054, and waits until a collation determination end signal is received. Collation determining unit 1054 collates and determines (step T17). Specifically, the similarity score represented by the value of variable P(A, B) stored in memory 102 is compared with a predetermined threshold T for collation. As a result of comparison, if P (A, B)≧T, it is determined that images A and B are taken from one same fingerprint, a value, for example, ‘1’, indicating a ‘match’ is written to a prescribed address of memory 102 as a collation result, and if not, the images are determined to be taken from different fingerprints and a value, for example, ‘0’, indicating a ‘mismatch’ is written to a prescribed address of memory 102, as a collation result. Thereafter, a collation determination end signal is transmitted to control unit 108, and the process ends.

Finally, control unit 108 outputs the collation result stored in memory 102 through display 610 or printer 690 (step T18), and the image collating process ends.

In the present embodiment, part of or all of the image correcting unit 1051, registering unit 1055, registered data reading unit 1056, maximum matching score position searching unit 1052, similarity score calculating unit 1053, collation determining unit 1054 and control unit 108 may be implemented by an ROM such as memory 624 storing the process procedure as a program and a processor such as CPU 622.

### Embodiment 2

The process functions of processing apparatus 1 with authentication function described above are implemented by a program. The program may be stored in a computer readable recording medium and may be provided as a program product.

As for the recording medium, in the present embodiment, the program medium may be a memory necessary for the processing by the computer, such as memory 624, or, alternatively, it may be a recording medium detachably mounted on an external storage device of the computer and the program recorded thereon may be read through the external storage device. Examples of such an external storage device are a magnetic tape device (not shown), an FD drive 630 and a CD-ROM drive 640, and examples of such a recording medium are a magnetic tape (not shown), an FD 632 and a CD-ROM 642. In any case, the program recorded on each recording medium may be accessed and executed by CPU 622, or the program may be once read from the recording medium and loaded to a prescribed storage area shown in FIG. 2, such as a program storage area of memory 624, and then read and executed by CPU 622. The program for loading is stored in advance in the computer.

Here, the recording medium mentioned above is detachable from the computer body. A medium fixedly carrying the program may be used as the recording medium. Specific examples may include tapes such as magnetic tapes and cassette tapes, discs including magnetic discs such as FD 623 and fixed disk 626 and optical discs such as CD-ROM 642/MO(Magnetic Optical Disk)/MD(Mini Disk)/DVD(Digital Versatile Disk), cards such as an IC card (including memory card)/optical card, and semiconductor memories such as a mask ROM, EPROM (Erasable and Programmable ROM), EEPROM (Electrically EPROM) and a flash ROM.

The computer shown in FIG. 2 has a configuration that allows connection to a communication network 300 including the Internet for establishing communication. Therefore, the program may be downloaded from communication network 300 and held on a recording medium in a non-fixed manner. When the program is downloaded from communication network 300, the program for downloading may be stored in advance in the computer, or it may be installed in advance from a different recording medium.

The contents stored in the recording medium are not limited to a program, and may include data.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An information processing apparatus, comprising:
a storage unit storing a degree of security set for a function of the information processing apparatus, and a function valid time corresponding to said degree of security;
an authentication information obtaining unit obtaining authentication information as a piece of information for identifying a user;
an authentication unit authorizing use of said function by said user, using said authentication information; and
a control unit requesting, when it is detected that the function valid time corresponding to the degree of security set for said function has elapsed since the start of use of said function, said authentication information and causing said authentication unit to execute said authentication.

2. The information processing apparatus according to claim 1, wherein
said function includes a first function and a second function;
said degree of security includes a first degree of security and a second degree of security lower than said first degree of security;
a first function valid time corresponding to said first degree of security is shorter than a second function valid time corresponding to said second degree of security; and
when said first degree of security is set for said first function and said second degree of security is set for said second function, said control unit requests, when it is detected that said first function valid time has elapsed since the start of use of said function, said authentication information related to use of said first function to execute said authentication, and when it is detected that said second function valid time has elapsed, said authentication information related to use of said second function to execute said authentication.

3. The information processing apparatus according to claim 2, wherein
said first function includes a function of electronic commercial transaction.

4. The information processing apparatus according to claim 2, wherein
said second function includes an electronic mail processing function and a call processing function.

5. The information processing apparatus according to claim 1, wherein
said control unit limits use of said function by said user, when authentication of said user at said authentication unit fails.

6. The information processing apparatus according to claim 1, wherein
said authentication information is information derived from biologic body.

7. The information processing apparatus according to claim 6, wherein
said information derived from biologic body is a fingerprint image.

8. The information processing apparatus according to claim 7, wherein
said authentication information obtaining unit obtains first and second fingerprint images as said authentication information; and
said authentication unit includes
a maximum matching score position searching unit searching for a position of an image of a partial area having maximum matching score in said second fingerprint image, corresponding to each of a plurality of partial areas set in said first fingerprint image,
a similarity score calculating unit calculating a similarity score between said first and second fingerprint images and outputting an image similarity score, using information related to that partial area of which positional relation amount is within a prescribed range, said positional relation amount representing positional relation between a reference position, for each of said partial areas, for specifying a position of the partial area within said first fingerprint image, and said maximum matching score position corresponding to the partial area searched out by said maximum matching score position searching unit, and
determining unit determining whether said first and second fingerprint images match or not, based on said image similarity score.

9. The information processing apparatus according to claim 8, wherein
said similarity score calculating unit calculates and outputs as said image similarity score, the number of said partial areas of which distance and direction of said maximum matching score position searched by said maximum matching score position searching unit from said reference positions are within said prescribed range among said plurality of partial areas.

10. In an information processing apparatus storing a degree of security set for a function and a function valid time corresponding to the degree of security, a method of authentication, comprising:
authentication information obtaining step of obtaining authentication information as information for identifying a user;
authentication step of authorizing use of said function by said user using said authentication information; and
control step of requesting, when it is detected that the function valid time corresponding to the degree of security set for said function has elapsed since the start of use of said function, said authentication information and executing said authentication.

11. A program product causing an information processing apparatus to execute an authentication process, wherein
said information processing apparatus stores a degree of security set for a function and a function valid time corresponding to the degree of security;
said authentication process including
authentication information obtaining step of obtaining authentication information as information for identifying a user;
authentication step of authorizing use of said function by said user using said authentication information; and
control step of requesting, when it is detected that the function valid time corresponding to the degree of security set for said function has elapsed since the start of use of said function, said authentication information and executing said authentication.
